(19) United States
(12) Patent Application Publication
(10) Pub. No.: US 2004/0235380 A1
(43) Pub. Date: Nov. 25, 2004

(54) Cross-directionally stretched barrier fabrics and methods of making same

(76) Inventor: Rene Kapik, Greensboro, NC (US)

Correspondence Address: MYERS BIGEL SIBLEY & SAJOVEC, PO BOX 37428, RALEIGH, NC, 27627, US

(21) Appl. No.: 10/678,827

(22) Filed: Oct. 3, 2003

Related U.S. Application Data
(60) Provisional application No. 60/472,083, filed on May 21, 2003.

(51) Int. Cl. B32B 27/04; B05D 3/12; D04H 3/00; D04H 3/16; D06C 3/00; D04H 1/56; B32B 5/02

(52) U.S. Cl. 442/79; 427/359; 427/372.2; 442/400; 442/382; 428/196; 442/409; 442/401; 428/198

(57) ABSTRACT

Methods of making a barrier fabric include providing a web of nonwoven material that includes at least one meltblown nonwoven layer, applying a barrier finish to the web such that the web serves as a barrier to liquids, stretching the web in a widthwise or cross machine direction without hindering barrier properties of the web, and subjecting the web to conditions sufficient to cure the barrier material.

### RELATED APPLICATION

This application claims the benefit of U.S. Provisional Application No. 60/472,083 filed May 21, 2003, the disclosure of which is incorporated herein by reference in its entirety as if set forth fully herein.

### FIELD OF THE INVENTION

The present invention relates generally to fabrics and, more particularly, to barrier fabrics that are substantially impervious to liquids.

### BACKGROUND OF THE INVENTION

A barrier fabric is a fabric that has been rendered at least somewhat impervious to liquids, such as water, blood, alcohol, body fluids, etc. Barrier fabrics are utilized in surgical gowns and other protective apparel where it is important to protect persons from exposure to liquids. Of significant concern is exposure to body fluids, such as blood, which may contain pathogens (e.g., bacteria, viruses, etc.). In a hospital environment, of particular concern is contact with body fluids containing human immunodeficiency virus and hepatitis virus. Other applications for barrier fabrics include medical devices such as drapes, instrument wraps and table covers.

During fabrication, barrier fabrics are conventionally “necked” or “reversibly necked” to soften the material. These processes involve stretching the fabric in the machine direction (i.e., elongated, lengthwise direction) and then letting the material recover to the original width. For example, U.S. Pat. Nos. 4,965,122; 6,372,172; and 5,770,531 describe necking and reversibly necking. These processes are careful to impart stretch only along the lengthwise direction (also referred to as the “machine direction”) of a fabric. Stretching of the fabric in a widthwise direction (also referred to as “cross direction”) via conventional methods of production has been avoided because traditionally it degrades the barrier characteristics of the fabric.

Manufacturers are continuously seeking better, more cost effective ways of producing barrier fabrics, particularly stronger and lighter weight barrier fabrics.

### SUMMARY OF THE INVENTION

In view of the above discussion, barrier fabrics and methods of making same are provided. According to an embodiment of the present invention, a barrier fabric includes a web of nonwoven material having at least one meltblown nonwoven layer, and a barrier finish applied to the web that serves as a barrier to liquids. The web is stretched in a widthwise or cross machine direction between about one percent and about twenty percent (1%-20%) of an unstretched width without hindering barrier properties of the web.

Methods of making a barrier fabric according to embodiments of the present invention include providing a web of nonwoven material that includes at least one meltblown nonwoven layer, applying a barrier finish to the web such that the web serves as a barrier to liquids, stretching the web in a widthwise or cross machine direction without hindering barrier properties of the web, and subjecting the web to conditions sufficient to cure the barrier material.

According to embodiments of the present invention, stretching may be preceded by heating the web to a predetermined temperature or within a predetermined range of temperatures. Stretching may include stretching the web between about one percent and about twenty percent (1%-20%) of an initial width of the web. Stretching may be performed in various ways including, but not limited to, via a tenter frame, via a pair of interdigitating rolls, or via a series of bow rolls. According to embodiments of the present invention, curing the barrier material may occur substantially simultaneously with stretching.

According to another embodiment of the present invention, a fibrous laminate that can serve as a barrier fabric includes first and second fibrous layers having fibers with a diameter greater than ten microns (10 μm), and a third fibrous layer having fibers with a diameter less than ten microns (10 μm) sandwiched between the first and second layers. The third fibrous layer serves as a barrier to liquids. The first, second and third layers can be bonded together at multiple spaced-apart locations, and the fibrous laminate is stretched in a widthwise or cross machine direction between about one percent and about twenty percent (1%-20%) of an unstretched width without hindering barrier properties of the third fibrous layer.

Methods of making a fibrous laminate that can serve as a barrier fabric according to embodiments of the present invention include providing first and second fibrous layers having fibers with a diameter greater than ten microns (10 μm), and providing a third fibrous layer having fibers with a diameter less than ten microns (10 μm). The third fibrous layer is sandwiched between the first and second layers and serves as a barrier to liquids. The first, second and third layers are bonded together at multiple spaced-apart locations to form a fibrous laminate. The fibrous laminate is stretched in a widthwise or cross machine direction without hindering barrier properties of the third fibrous layer.

### BRIEF DESCRIPTION OF THE DRAWINGS

The accompanying drawing, which forms a part of the specification, illustrates embodiments of the present invention. The drawing and description together serve to fully explain the invention.

FIG. 1 is a flowchart of operations for producing barrier fabrics in accordance with embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “nonwoven fabric”, refers to a fabric that has a structure of individual fibers or threads which are interlaid, but not in any regular, repeating manner. Nonwoven fabrics may be formed by a variety of processes, such as, for example, meltblowing processes, spunbonding processes and bonded carded web processes.

As used herein, the term “polymer” generally includes, but is not limited to, homopolymers, copolymers, such as, for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiaotactic and random symmetries.

As used herein, the terms “laminate” and “composite” are intended to be used interchangeably and are used to describe fabric structures having two or more layers.

Embodiments of the present invention provide improved barrier fabrics and methods of producing same, specifically barrier fabrics comprised of two or more layers including a meltblown microfiber layer, that impart stretch to the fabric in the cross machine direction and retain that stretch as a net width gain, while maintaining the barrier properties. Barrier fabrics in accordance with embodiments of the present invention may be used in various types of articles, especially protective apparel such as surgical or emergency room gowns, where liquid and pathogen blockage are important. Exemplary protective apparel with which barrier fabrics according to embodiments of the present invention may be used include, but are not limited to, gowns, coveralls, gloves, arm shields, hoods, boots, aprons, finger cots and the like. In addition, barrier fabrics in accordance with embodiments of the present invention may be used in cleanroom and/or laboratory garments.

Barrier fabrics according to embodiments of the present invention may have a composite structure wherein one or more additional layers of fabric are utilized. For example, a composite may contain one or more layers that provide strength to the composite. A typical structure for this application would be a spunbond-meltblown-spunbond (SMS) nonwoven. SMS nonwovens are spunmelt nonwoven fabrics that have a top and bottom layer of a spunbond fabric which is prepared from thermoplastic spinnable polymer. The fibers are typically larger than ten microns (10 μm) in diameter and provide strength. The barrier or middle layer may be one or more webs of microfiber meltblown nonwoven. The entire composite is bonded together using ultrasonic or thermal bonding at multiple spaced apart locations.

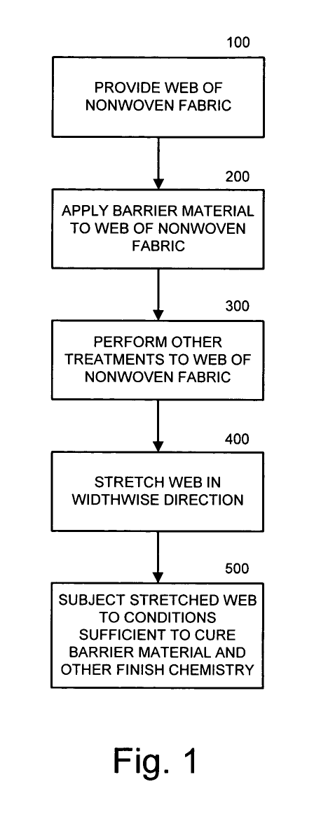

Referring to FIG. 1, methods of producing barrier fabrics in accordance with embodiments of the present invention are illustrated. A web of nonwoven fabric is provided (Block 100). The web fabric may be a single layer or a multiple layer composite. An exemplary nonwoven fabric is an SMS nonwoven fabric that contains at least one meltblown nonwoven layer.

Nonwoven fabrics utilized in accordance with embodiments of the present invention may include synthetic fibers (e.g., nylon, polyester, acrylic, polyolefins, modacrylic, polyvinyl chloride, polyvinylidene chloride, urethane, copolyether ester, copolyether amide, etc.), natural fibers (e.g., wood fibers, cotton fibers, etc.), or a blend of synthetic and natural fibers. A nonwoven fabric according to embodiments of the present invention may be made of fiber forming polymers such as, for example, polyolefins. Exemplary polyolefins include one or more of polypropylene, polyethylene, ethylene copolymers, propylene copolymers, and butene copolymers.

The web of nonwoven fabric is contacted with a barrier material in liquid form (i.e., a layer or coating of barrier material is applied to the web of nonwoven fabric in some manner) (Block 200). Other treatments to the web (referred to as “finish chemistry”) may be performed as well (Block 300). For example, the web may be treated with a finish that provides antistatic capability and/or with a finish that provides liquid repellency. The barrier material, as well as other treatment materials added to the web, may be applied via an aqueous bath, or via other methods well known to those skilled in the art including, but not limited to, dipping, spraying, gravure, slot-die, screen print, knife coat. Moreover, the barrier material (as well as other treatment materials) may be applied to one or both sides of the web. The web is then stretched in a widthwise or cross direction (i.e., in a direction transverse to the machine direction) (Block 400) and maintained in a stretched configuration while the web is subjected to conditions sufficient to cure the barrier material and other treatment materials (Block 500).

Curing and stretching in a widthwise direction may be performed in a variety of ways including, but not limited to tenter frames, interdigitating rolls and bow rolls.

According to one embodiment, the web is mounted onto a tenter frame that is configured to stretch the fabric in a widthwise direction. Tenter frames are well known to those skilled in the art and need not be described further herein. Various curing methods may be utilized including, but not limited to flotation curing, through-air curing, infrared curing, and microwave curing.

Applicant's have unexpectedly found that, by using a tenter frame during curing, the web can be gradually and controllably stretched. This is advantageous over conventional barrier fabric manufacturing techniques because the tenter frame can be set up to stretch quickly over a short distance, or gradually over a longer distance. This allows for uniform expansion of the web to take place.

Moreover, the tenter frame can be overfed. Overfeeding is the opposite of necking. This means that fabric can be fed to the equipment at a rate slightly higher than the chain speed. Overfeeding is a process where a sheet structure is forcibly fed into a process at a rate that exceeds the rate of the subsequent process. Overfeeding is used to build weight, and replace mass that is lost when expanding the sheet through stretching. This allows for even distribution and maintenance of the basis weight.

By utilizing the ability to pre-dry and also profile the temperature of the drying and curing, the fabric may be stretched during a heat induced expansion phase. Applicant has unexpectedly found that fabrics of the type described herein will relax and expand when warmed. This expansion stops as heating increases and reverses to cause shrinkage as the softening point of the polymer is approached. This takes advantage of the inherent nature of the fabric to relax initially when heated. The tentering process allows the achievement of the expansion before the fabric and the barrier material (and other treatment materials) are cured and set. Stretching after curing and setting will degrade the barrier performance.

Embodiments of the present invention do not require special chemical softeners or polymer additives to be successful. Moreover, embodiments of the present invention do not require necking to be successful, and results in a net yield gain versus a yield loss for necking.

An exemplary composite fabric produced in accordance with embodiments of the present invention includes three layers with the top layer and the bottom layer comprising a nonwoven web of fibers greater than about ten microns (10 μm) in diameter. The center layer provides the barrier properties and is comprised of microfibers with a diameter less than ten microns (10 μm). The top and bottom layers provide strength, and aesthetics while the center layer provides barrier properties, opacity, and filtration efficiency. The various layers of the fabric are formed from thermoplastic polymers.

The composite fabric is autogenously bonded at multiple spaced-apart locations using patterned thermal or ultrasonic bonding. The bond area may be from between about two percent to about twenty-five percent (2%-25%) of the square area of the fabric. Fabrics such as those marketed under the EVOLUTION® brand by Kimberly Clark Corp, under the SECURON™ brand by BBA Nonwovens Inc., and under the SUPREL® brand by DuPont Co. are examples of this type of composite fabric. The composite fabric is then finished to impart low surface tension liquid repellency, and antistatic properties.

An exemplary formulation for finishing would be 0.58% n-hexanol, 1.0% of a fluorochemical dispersion, and 0.2% antistat. The hexanol provides wetting to the formula, the fluorochemical provides low surface tension repellency, and the antistat provides electrical conductivity to dissipate static charge. Fluorochemicals such as Zonyl 7040 from DuPont, or Unidyne TG-532 from Daikin America, or FC808 from 3M Corp. would be exemplary choices for the fluorochemical. Phosphate ester antistats such as Zelec Ty from Stepan Corp would be an exemplary antistat.

In a typical process, the composite fabric is saturated with the above aqueous formulation and then the excess chemistry removed by squeeze roller, or other known method. The composite fabric is then dried and cured at about 140° C. for about 20 seconds. Exemplary properties for the finished product prior to stretching in accordance with embodiments of the present invention are set forth below in Table 1:

TABLE 1

| PROPERTY | TEST* | VALUE |
|---|---|---|
| Weight | INDA IST 130.1 | 40-70 grams/sq meter |
| Grab Tensile | INDA IST 110.1 | minimum 15 # each direction |
| Alcohol Rating | INDA IST 80.8 | minimum 7 |
| Hydrostatic Head | INDA IST 80.6 | 35-120 cm |
| Water Impact | INDA IST 80.3 | <2 grams |
| Electrostatic Decay | INDA IST 40.2 | <0.5 sec |

*All test methods from INDA STM methods 2002.

The results of Table 1 indicate the composite fabric is fit for use as a barrier fabric in medical applications in an unstretched configuration. The composite fabric is then stretched in a widthwise direction via tentering by about 20% with no loss in performance as a barrier fabric.

In one embodiment of the invention, the finish chemistry is applied to the composite fabric at greater than 90% pick-up, often greater than 100% pick-up, and more often greater than 120% pick-up, and then the composite fabric is immediately delivered to a tenter frame. Once attached to the pins or clips of the tenter frame, the tenter frame rails are set to move the width of the composite fabric out to a new stretched width. Stretching may be done at ambient temperature or with warming. The composite fabric then proceeds to drying and curing with no further changes in width.

According to another embodiment of the present invention, the composite fabric has finish chemistry applied at greater than 90% pick-up, often greater than 100% pick-up, and more often greater than 120% pick-up and then is overfed onto the pins of a pin tenter. A pin tenter carries a fabric or other sheet structure into and through an oven by supporting the sheet from the selvedge using metal plates lined with small pins. The pins puncture the fabric and hold it as the web is passed through the oven. The pin plates are mounted on a chain that is run on a continuous loop through the oven. (A clip tenter frame could be used for stretching without overfeeding.) The fabric is overfed between about 1% to about 6%. The rails of the tenter frame are set to expand the composite fabric and thereby impart stretch thereto.

Referring back to FIG. 1, according to another embodiment of the present invention, the step of stretching a fabric in the widthwise direction may include simultaneously heating the fabric. Heating may cause the fabric to “relax” and thereby result in a more uniform stretch

According to another embodiment of the present invention, the fabric would be passed through a series of bow rolls to impart the stretch. This would be done either at ambient conditions or while heating.

According to another embodiment of the present invention, the fabric is passed through a set of interdigitating or “ring” rolls. This device consists of a set of thin knife like discs on two central shafts. The two ring rolls are set to extend into each other with the individual rings meshing together. An example of interdigitating rolls is described in U.S. Pat. No. 5,628,097 which is incorporated herein by reference in its entirety. When the fabric is passed through the interdigitating rolls, the fabric is incrementally stretched between each set of knife edges along the width. This process imparts very uniform expansion of the sheet and may be done at ambient conditions or while heating.

According to other embodiments of the present invention, stretching in the cross direction may be performed by passing the fabric through a series of bow rolls. Bow rolls are well known to those of skill in the art and need not be described further herein.

The following example is provided in order to further illustrate various embodiments of the invention and are not to be construed as limiting the scope thereof.

### EXAMPLE 1

A 1.55 oz/square yard, 127.5″ wide, polypropylene SMS barrier fabric was acquired. This material was unrolled into a bath composed of 1.2% Daikin TG-532 fluorochemical, 0.14 Zelec TY antistat, and 0.58% n-hexanol. The saturated fabric was nipped back to 130% wet pick up. The bath temperature was 90° F. The fabric was then pinned onto the rails of a Bruckner tenter frame. The tenter frame was 120 feet in length, with a 30 foot section of entry rails outside the actual oven. The entry rails were equipped, top and bottom, with electrically heated infrared pre-heaters. The fabric entered the rails at 126″ wide due to the normal width loss from entry tension. The rails were ten feet (10 ft.) apart and the widths were set at 125″, 132″, 136″, then 136″ through the next 9 rail settings. The fabric was stretched an overall 7.94% through the process. No overfeed was used. The temperature was applied by infrared heaters over the stretching process at a set point of 170° F. The oven temperature was profiled from 305° F. at the entry and first thirty feet of the oven to 270° F. in the center seventy feet, then 265° F. for ten feet, then 240° F. for the final ten feet. The data from this trial fabric is compared to standard unstretched fabric in TABLE 2 below.

TABLE 2
Comparison of Un-Stretched versus CD Stretch Trials

| | | | | Test Results | |
|---|---|---|---|---|---|
| | | | Statistical | (Doff Average) | |
| | | | Equalency? | 204150 | 400848 |
| | | | (E = equal) | (n = 17 to 49) | (n = 4) |
| Property | Units | Direction | (NE = not equal) | control | stretched |
| Basis Weight | Osy | | NE | 1.51 | 1.45 |
| Water Impact | G | | E | 0.11 | 0.27 |
| Porosity | Cfm | | E | 48.1 | 49.3 |
| Grab Tensile | Lb | MD | NE | 31.8 | 31.0 |
| | | CD | E | 17.0 | 16.9 |
| Grab Elongation | % | MD | E | 47.2 | 45.7 |
| | | CD | NE | 71.7 | 62.3 |
| Trapezoid Tear | Lb | MD | E | 4.5 | 4.4 |
| | | CD | E | 9.9 | 9.3 |
| HOM | G | MD | E | 57.1 | 53.5 |
| | | CD | NE | 28.3 | 34.3 |
| Alcohol Rating | Rating | | E | 8.4 | 8.0 |
| Hydrostatic Head | Cm | | E | 72.4 | 70.6 |
| Quick-check Static | Sec | MD | E | 0.022 | 0.025 |
| Decay | | CD | E | 0.05 | 0.04 |

TABLE 2 illustrates that, by stretching barrier fabric in a cross machine direction, in accordance with embodiments of the present invention, a greater yield of material can be obtained without hindering barrier properties of the fabric.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. The invention is defined by the following claims, with equivalents of the claims to be included therein.

That which is claimed is:

1. A method of preparing a barrier fabric, comprising:
providing a web of nonwoven material including at least one meltblown nonwoven layer, wherein the web has a lengthwise direction and a widthwise direction;
applying a barrier finish to the web such that the web serves as a barrier to liquids;
stretching the web in the widthwise direction without hindering barrier properties of the web; and
subjecting the web to conditions sufficient to cure the barrier finish.

2. The method of claim 1, wherein stretching is preceded by heating the web to a predetermined temperature.

3. The method of claim 1, wherein applying a barrier finish to the web comprises subjecting the web to an aqueous bath of barrier material.

4. The method of claim 1, wherein stretching the web comprises stretching the web between about one percent and about twenty percent (1%-20%) of an initial width.

5. The method of claim 1, wherein stretching is performed via a tenter frame.

6. The method of claim 1, wherein stretching is performed by passing the web through a pair of interdigitating rolls.

7. The method of claim 1, wherein stretching is performed by passing the web through a series of bow rolls.

8. The method of claim 1, wherein subjecting the web to conditions sufficient to cure the barrier material occurs substantially simultaneously with stretching.

9. A method of preparing a barrier fabric, comprising:
providing a fibrous laminate having a lengthwise direction and a widthwise direction, wherein the fibrous laminate comprises:
first and second fibrous layers having fibers with a diameter greater than ten microns (10 μm); and
a third fibrous layer having fibers with a diameter less than ten microns (10 μm) sandwiched between the first and second layers, wherein the third fibrous layer serves as a barrier to liquids;
wherein the first, second and third layers are bonded together at multiple spaced-apart locations; and
stretching the fibrous laminate in the widthwise direction without hindering barrier properties of the third fibrous layer.

10. The method of claim 9, wherein the first and second fibrous layers are spunbond nonwoven layers and wherein the third layer is a microfiber meltblown nonwoven layer.

11. The method of claim 9, wherein the first, second and third layers are bonded together between about two percent and about twenty five percent (2%-25%) of a surface area of the fibrous laminate.

12. The method of claim 9, wherein the first, second and third layers are autogenously bonded together

13. The method of claim 9, wherein the first, second and third layers are autogenously bonded together ultrasonically.

14. The method of claim 9, wherein the first, second and third layers are bonded together in a continuous bond pattern.

15. The method of claim 9, wherein the first, second and third layers are bonded together in multiple, spaced apart bond patterns.

16. The method of claim 9, further comprising applying a finish to the fibrous laminate to impart liquid repellency to the fibrous laminate prior to stretching.

17. The method of claim 16, wherein the finish comprises a mixture of n-hexanol and fluorochemical dispersion.

18. The method of claim 9, further comprising applying a finish to the fibrous laminate to impart antistatic properties to the fibrous laminate prior to stretching.

19. The method of claim 18, wherein the finish comprises an antistat.

20. The method of claim 9, wherein stretching is preceded by heating the fibrous laminate to a predetermined temperature.

21. The method of claim 9, wherein stretching the fibrous laminate comprises stretching the fibrous laminate between about one percent and about twenty percent (1%-20%) of an initial width.

22. The method of claim 9, wherein stretching is performed via a tenter frame.

23. The method of claim 9, wherein stretching is performed by passing the fibrous laminate through a pair of interdigitating rolls.

24. The method of claim 8, wherein stretching is performed by passing the fibrous laminate through a series of bow rolls.

25. A barrier fabric, comprising:
a web of nonwoven material including at least one meltblown nonwoven layer, wherein the web has a lengthwise direction and a widthwise direction; and
a barrier finish applied to the web that serves as a barrier to liquids;
wherein the web is stretched in the widthwise direction between about one percent and about twenty percent (1%-20%) of an unstretched width without hindering barrier properties of the web.

26. A fibrous laminate, comprising:
first and second fibrous layers having fibers with a diameter greater than ten microns (10 μm); and
a third fibrous layer having fibers with a diameter less than ten microns (10 μm) sandwiched between the first and second layers, wherein the third fibrous layer serves as a barrier to liquids;
wherein the first, second and third layers are bonded together at multiple spaced-apart locations;
wherein the fibrous laminate is stretched in a widthwise direction between about one percent and about twenty percent (1%-20%) of an unstretched width without hindering barrier properties of the third fibrous layer.

27. The fibrous laminate of claim 26, wherein the first and second fibrous layers are spunbond nonwoven layers and wherein the third layer is a microfiber meltblown nonwoven layer.

28. The fibrous laminate of claim 26, wherein the first, second and third layers are bonded together between about two percent and about twenty five percent (2%-25%) of a surface area of the fibrous laminate.

29. The fibrous laminate of claim 26, wherein the first, second and third layers are autogenously bonded together

30. The fibrous laminate of claim 26, wherein the first, second and third layers are bonded together in a continuous bond pattern.

31. The fibrous laminate of claim 26, wherein the first, second and third layers are bonded together in multiple, spaced apart bond patterns.
